(19) United States
(12) Patent Application Publication
(10) Pub. No.: US 2011/0286300 A1
(43) Pub. Date: Nov. 24, 2011

(54) MIXER

(75) Inventors: Henning KREIS, Ahnatal/Heckershausen (DE); Thomas Schill, Berkatal (DE); Cord Schmidthals, Warburg (DE)

(73) Assignee: ZEPPELIN REIMELT GMBH, Roedermark (DE)

(21) Appl. No.: 13/090,310

(22) Filed: Apr. 20, 2011

(30) Foreign Application Priority Data
Apr. 22, 2010 (DE) 10 2010 016 595.6

(51) Int. Cl. B01F 9/00; B01F 15/02

(52) U.S. Cl. 366/188; 366/343

(57) ABSTRACT

A mixer (1) comprises a rotatable mixing container (2), a container drive (7) for the mixing container (2), a mixing head (5) which can be attached in the mixing container (2), with a rotatably mounted mixing tool (10) and a tool drive (4) for the mixing tool (10), wherein the mixing container (2) is configured as a dimensionally stable mesh (21), wherein the interior of the mixing container (2) is designed with a replaceable, flexible insert (22) which curves into the intermediate spaces (24) of the mesh (21) when the mixing container (2) is filled with a material to be mixed.

### CROSS-REFERENCE TO RELATED APPLICATION

This application claims benefit of and priority to German Patent Application No. 10 2010 016 595.6, filed on Apr. 22, 2010, the content of which Application is incorporated herein by reference.

The present disclosure relates to a mixer that includes a rotatable mixing container including a container drive, a mixing head attached in the mixing container, a rotatably mounted mixing tool, and a tool drive to drive the mixing tool.

Generic mixers of this type are known in numerous embodiments. They includes, for example, a rotatable mixing container, a mixing tool rotatably mounted in the mixing container and a drive for the mixing tool. The mixing container can be pivoted from a vertical position into any other position by a container drive.

In operation, the mixing container of the mixer can be moved into a docking station provided for this purpose after introducing the material to be mixed. After the docking, the mixing container is pivoted from a vertical position into another position in which the actual mixing process takes place. The advantage in this procedure is that the mixing container can serve as a transport container for the material to be mixed within operation both of the unmixed material to be mixed and also of the ready-mixed material to be mixed. As a result, additional devices or conveying systems for conveying the unmixed material to be mixed or the ready-mixed material to be mixed are thereby eliminated.

Such mixers are predominantly used in applications in which a frequent product change takes place, for example, during the production of pigment mixtures, so-called master batches as well as mixtures of additives. These mixtures are used, for example, as additives to plastics for the production of most diverse end products such as, for example, containers for cosmetics, shampoo, and also window profiles or other technical profiles.

As a result of the need for a frequent change of products in these applications, the cleaning of the mixer between the actual mixing cycles acquires a particular importance. Depending on the type of product, cleaning times of up to 30 minutes are required in the present mixers. In this case, the essential components of the mixer in contact with product are the mixing head, the tool and the mixing container. In operating practice, however, neither the mixing head as a stationary machine nor the tool that can only be dismounted with some effort, can be inserted in a suitable cleaning apparatus. Consequently, only a cleaning on site by mechanical disposal and removal of product residue, for example, by vacuum cleaners comes into consideration. However, as a result of the appreciable size of the mixing container in some cases, cleaning in suitable stations is very laborious.

The present disclosure provides for a mixer which can be cleaned simply, rapidly and inexpensively.

The present disclosure thus relates to a mixer that includes a rotatable mixing container including a container drive, a mixing head attached in the mixing container, a rotatably mounted mixing tool, and a tool drive to drive the mixing tool. The mixing container is configured to include a dimensionally stable mesh. An interior of the mixing container includes a replaceable, flexible insert which curves into intermediate spaces of the mesh when the mixing container is filled with a material to be mixed.

According to the present disclosure, the mixing container is configured as a dimensionally stable mesh, wherein the interior of the mixing container is designed with a replaceable, flexible insert which curves into the intermediate spaces of the mesh when the mixing container filled with a material to be mixed.

The use of such an insert affords a major advantage that in the event of a product change, the cleaning of the inner walls of the mixing container can be eliminated. Instead, the insert itself is removed from the mixing container and disposed of. The formation of the mixing container as a dimensionally stable mesh furthermore has an advantage that upon filling of the mixing container with the material to be mixed, a slight curving of the insert into the openings of the mesh takes place. As a result, during the subsequent pivoting and rotating movement during the mixing process the insert prevents any slippage of the insert so that an additional fastening of the insert on the mixing container can be dispensed with. In addition, as a result of this curvature the friction of the material to be mixed against the wall of the mixing container is increased during the rotation of the material to be mixed and, therefore, additionally improves the entrainment of the material to be mixed during rotation of the mixing container.

Embodiments according to the present disclosure are discussed below.

According to an embodiment of the present disclosure, the mixing container is formed simply and inexpensively from a wire mesh.

According to a another embodiment of the present disclosure, the insert is formed as a plastic film or, according to another embodiment of the present disclosure, as a rubber matting. The formation of the insert as a plastic film is a very inexpensive variant.

According to another embodiment of the present disclosure, the insert may be formed with an outlet. And, in an area of a container outlet of the mixing container, a closure, which may be formed as a pinch valve, is provided, and by which closure a flow of material to be mixed through the outlet of the insert can be controlled. This allows easy metering of the ready-mixed material to be mixed.

Other aspects of the present disclosure will become apparent from the following descriptions when considered in conjunction with the accompanying drawings.

### BRIEF DESCRIPTION OF THE DRAWINGS

FIG. 1 shows a perspective view of an embodiment of a mixer, according to the present disclosure.

FIG. 2 shows a side view of a mixing container of a mixer, according to the present disclosure.

### DETAILED DESCRIPTION

In the following description, terms such as top, bottom, left, right, front, and behind are exemplary representations and positions of the mixer and other parts shown in the respective Figures. These terms are not to be understood as being restrictive. That is, these references can change, for example, due to different working positions or a mirror-symmetrical design.

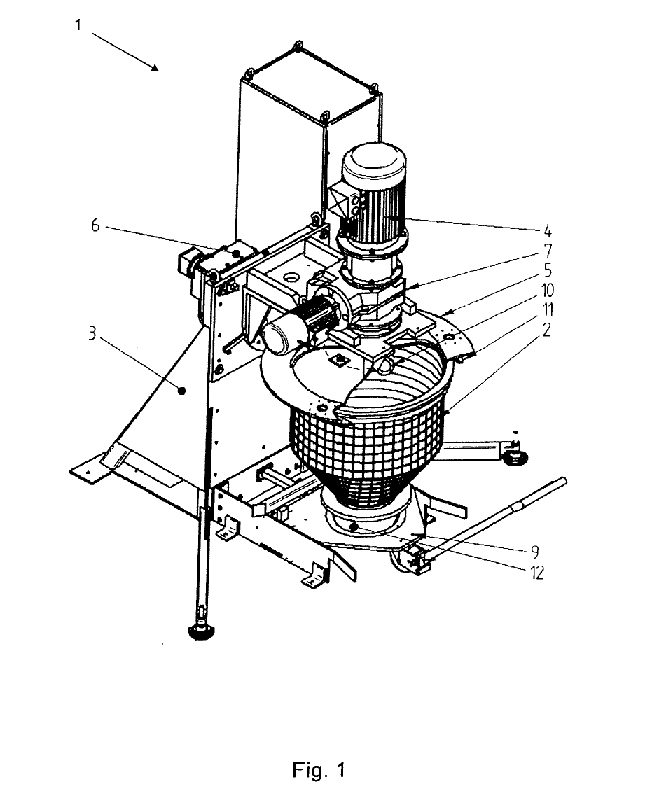

As shown in FIG. 1, a mixer 1 includes a mixing head 5, a mixing container 2 on which the mixing head 5 can be placed, and by which mixing head 5 the mixing container 2 can be closed. Also shown is a stand 3 on which the mixing head 5 is held. On a side of the mixing head 5 facing the mixing container 2, a mixing tool 10 is rotatably mounted, which tool 10 is fastened by a tool drive 4 on the side of the mixing head 5 facing away from the mixing container 2.

The mixing container 2 may be mounted on an underframe 9 which may be provided with a closure 12 by which closure 12 an outlet 13 attached to the underside of the mixing container 2 can be closed.

Two movable arms 11 which embrace the mixing container 2 circumferentially are furthermore provided on the stand 3 for docking the mixing container 2, and by which arms 11 the mixing container 2 can be fixed on the stand 3. When the mixing container 2 is docked onto the mixing head 5, it can be pivoted in this position by a pivoting drive 6 from a vertical position into a position about its longitudinal axis.

In the pivoted mixing position, the mixing container 2, including mixing head 5, can be rotated about its longitudinal axis by a container drive 7. At the same time, the tool 10 is rotated in the mixing head 5 with the aid of the tool drive 4 in a direction opposite to the direction of rotation of the mixing container 2 for processing the material to be mixed in the mixing container 2.

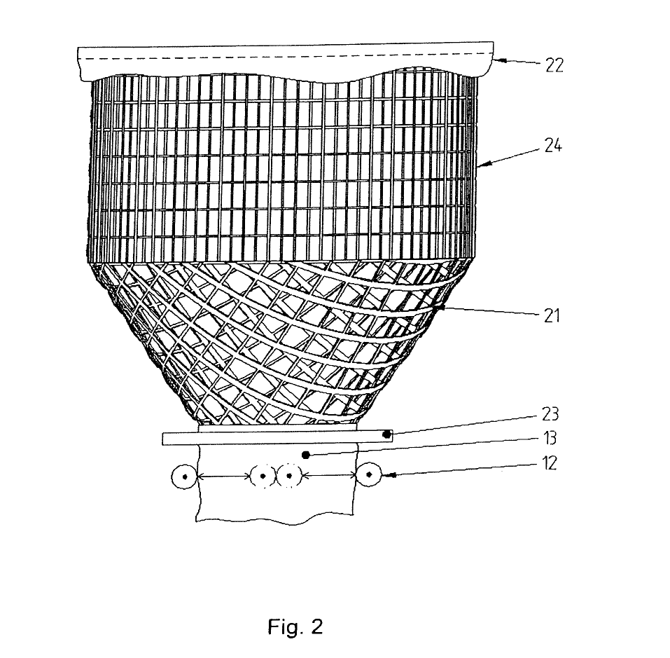

As shown in FIG. 2, the mixing container 2 is configured as a dimensionally stable mesh 21. The interior of the mixing container 2 includes a replaceable, flexible insert 22. This insert 22 curves into intermediate spaces 24 of the mesh 21 when the mixing container 2 is filled with the material to be mixed. A shell of the mixing container 2 may be formed from a wire mesh. However, it is within the scope of the present disclosure to form the shell of the mixing container 2, for example, from a perforated sheet.

The insert 22 may be formed from a plastic film, but a configuration as thin-walled rubber matting or as metal film is within the scope of the present disclosure. It is important that the insert 22 can be inserted simply into the mixing container 2 and the manufacturing costs of the single-use insert are correspondingly low. The material thickness of the insert 22 is determined so that a slight curving of the inert 22 into the intermediate spaces 24 of the mesh 21 is achieved due to the weight force of the filling material when filling the mixing container 2. As a result, an additional fastening of the insert 22 on the mesh 21 can be dispensed with since any movement of the insert 22 is effectively prevented by the curving of the insert 22 into the intermediate spaces 24 of the mesh. In addition, this curvature increases the friction of the material to be mixed against the inner wall of the mixing container 2 during rotation of the mixing container 2. This consequently improves the entrainment of the material to be mixed during the rotation of the mixing container 2.

On a region of the insert 22 near the container outlet 23 of the mixing container 2, an outlet 13 is provided. This outlet 13 may be opened and closed as desired by a closure 12 attached to the mixing container 2. The closure 12 may be a pinch valve and a flow of the material to be mixed through the outlet 13 of the insert 22 can be controlled according to the requirements of the subsequent process guidance. Such a closure 12 can, for example, in accordance with the present disclosure, be formed from two rods which can be pressed onto one another. Such rods may be formed as rubber-encased metal rods. For emptying the mixing container 2, the distance of the two rods may be increased by a motor or manually so that the material to be mixed can escape through the outlet 13 of the insert 22. In order to control an outlet speed of the material to be mixed, the closure 12 can, accordingly, increase or reduce the outlet of the insert 22 according to the requirements of the subsequent process guidance.

Although the present disclosure has been described and illustrated in detail, it is to be clearly understood that this is done by way of illustration and example only and is not to be taken by way of limitation. The scope of the present disclosure is to be limited only by the terms of the appended claims.

1. A mixer (1), comprising a rotatable mixing container (2), a container drive (7) for the mixing container (2), a mixing head (5) which can be attached in the mixing container (2), with a rotatably mounted mixing tool (10) and a tool drive (4) for the mixing tool (10), characterised in that the mixing container (2) is configured as a dimensionally stable mesh (21), wherein the interior of the mixing container (2) is designed with a replaceable, flexible insert (22) which curves into the intermediate spaces (24) of the mesh (21) when the mixing container (2) is filled with a material to be mixed.

2. The mixer (1) according to claim 1, characterised in that the mixing container (2) is formed from a wire mesh.

3. The mixer (1) according to claim 1 or 2, characterised in that the insert (22) is formed as plastic film.

4. The mixer (1) according to any one of the preceding claims, characterised in that the insert (22) is formed as rubber matting.

5. The mixer (1) according to any one of the preceding claims, characterised in that the insert (22) is formed with an outlet.

6. The mixer (1) according to claim 5, characterised in that in the area of the container outlet (23) of the mixing container (2), a pinch valve (12) is provided, by which means a flow of material to be mixed through the outlet of the insert (22) can be controlled.

7. The mixer (1) according to claim 6, characterised in that the pinch valve (12) is formed as two rods which can be pressed onto one another, in particular, rubber-encased metal rods, by which means the outlet can be closed in the completely compressed state.
